(19) United States
(12) Patent Application Publication
(10) Pub. No.: US 2008/0054640 A1
(43) Pub. Date: Mar. 6, 2008

(54) Air pump in float

(76) Inventor: Chris Olson, Houston, TX (US)

Correspondence Address: LAW OFFICE OF DAVID MCEWING, P.O. BOX 231324, HOUSTON, TX, 77023, US

(21) Appl. No.: 11/513,805

(22) Filed: Aug. 31, 2006

(51) Int. Cl. F03B 17/02; F03B 13/12; F03B 13/10; H02P 9/04

(52) U.S. Cl. 290/42; 60/495

(57) ABSTRACT

An air compression system for use on the ocean surface comprising an air compressor within a moveable float. The float also contains a drive rack engaged with a drive gear wherein the float moves substantially vertically up and down on the drive rack in response to ocean waves. The float also includes a retention spring to return the float vertically upward and a drive pulley connected to the drive gear moving in response to the float moving along the drive rack and powering the air compressor within the float. Also included is a method of utilizing wave motion to compress air comprising the steps of installing a float at the ocean surface wherein the float can move substantially up and down in response to wave motion and installing a drive rack within the float wherein one end of the drive rack is fixed to a beam that is relatively stable. The method further comprises placing a rotating drive gear that engages the drive rack and rotates as the float moves in relation to the drive rack, placing the rotatable drive gear in communication with further moveable component; and placing the moveable component in communication with a moveable piston of an air compressor.

### FIELD OF INVENTION

This invention pertains to an apparatus and method for pumping air utilizing the energy or motion of ocean waves.

### BACKGROUND OF INVENTION

Inventors have been trying to figure how to extract energy from the ocean for more than 150 years. The applicant has successfully achieved a method for converting wave energy into other energy forms. This invention is a variation of pending application Ser. No. 11/473357, entitled Ocean Wave Energy Converter filed Jun. 22, 2006 and which is incorporated herein by reference.

### SUMMARY OF INVENTION

The air compressor is contained within a float. There may be plurality of floats each containing an air compressor. The floats are connected by rods with one or more beams (being a long heavy component) that are suspended beneath the ocean surface by the buoyancy of the floats parallel to the ocean surface. The floats are a component that rises and falls with the ocean waves. This substantially vertical motion of the float along a rod (drive rack) can be converted to mechanical energy sufficient to operate an air compressor. The mass of the beam is substantially greater than the mass of a single float and holds the rod in a fixed position relative to the float.

The beam is suspended beneath the water surface (and below typical wave depth) by the buoyancy of multiple floats. The floats are at the ocean surface and move in response to the surface waves. The rods that protrude from the beam (which are extensions of the drive racks) will move in and out of the individual float with enormous force and that tension and release of tension is converted into a different form of energy as a result of the motion of machine components within the floats. The rods may have an articulated or pivoting relationship with the beam. The energy of the float's motion may be converted by machine subcomponents inside the float. The beams can be rigidly connected together to make squares, grid shapes or to increase the beam length. Connecting the beam in grid shapes provide an almost immovable object for the individual floats and drive racks to interact with.

### SUMMARY OF DRAWINGS

The accompanying drawings, which are incorporated by reference and constitute part of the specification, illustrate preferred embodiments of the invention. These drawings, together with the general description of the invention given above and the detailed description of the preferred embodiments given below serve to explain the principles of the invention.

FIG. 1 illustrates one embodiment of the device subject of the invention including the vertically elongated float containing the drive rack attached to a retention spring at the upper portion of the float. The drive rack extends from the bottom of the float and is attached to a beam suspended in the water beneath the float. Also illustrated in a drive gear attached to the float and engaged with the drive rack. The drive gear is in powered communication with an air compressor located within the float. An air inlet is placed at the top of the float and communicates with the air compressor. A separate air line conveying compressed air may, in one embodiment, extend through the length of the drive rack to a collection point within the beam.

FIG. 2 illustrates the relationship between the plurality of floats and the grid shaped beam with the compressed gas storage devices.

### DETAILED DESCRIPTION OF THE INVENTION

The apparatus takes into account the difficult obstacles that have prevented other devices from being successfully used as power generators. These are some of the problems this apparatus solves: (A) The apparatus has no moving parts that are exposed to the salt water. (B) The beam uses its own mass to act against the pulling forces of the floats, so it does not having to be tightly fastened to the ocean floor. (C) The beam does not have to mechanically adapt to the change in height of the tide. (D) The beam will be submerged deep enough so that ships cannot damage it. (E) The machine components may make energy in both directions as the individual floats add and release tension on the retention springs. (F) The beam is protected from storms and large waves because it is well below the ocean surface. (G) The huge cost saving of not having to anchor tightly to the ocean floor will make this apparatus more cost effective. (H) One anchor can hold numerous floats. (I) Beachfront property has too many swimmers and fisherman that make it unlikely that there will ever be many wave power generator allowed on the beach. This machine and its floats will be far from shore, and the floats will have a low profile. (J) The machine components of the apparatus may be designed to produce large amounts of electricity or energy for production of compressed air. (K) The machine can quickly be raised to the surface for repairs and re-submerged.

The machine components are designed to work within the difficult ocean conditions. The beam of the apparatus will be deeply submerged so boats and vessels will not come in contact with it. It will also be submerged below the wave component. The floats will not harm or be harmed during contact with boats. Marine life will appreciate the shade. The machine components (which are attached or incorporated into one or more floats) will be watertight using rubber bellows or other suitable materials to seal the moving parts. The anchoring will only be to keep the apparatus from drifting. The energy conversion operation of the apparatus does not require that the beam be secured to the ocean floor.

This invention is subject of pending application Ser. No. 11/473357, entitled Ocean Wave Energy Converter filed Jun. 22, 2006 and which is incorporated herein by reference. The float device described in this application is one example of float devices that could be used with the Ocean Wave Energy Converter.

One attribute of the invention is that the machine component located in the float(s) utilizes the stable mass that is suspended below the ocean surface. Each float independently moves in response to wave action. Each float thereby independently creates motion having a vertical component which can be used to power a machine, i.e., an air compressor. This vertical motion of other floats can be aggregated by the operation of other machines in each float. The aggregation of the rising and falling of the multiple buoyant floats take turns preventing the beam from sinking to the ocean floor.

The simple design of the apparatus will survive in the ocean where others fail. Floats working together to continuously re-distribute the weight of the heavy beam and convert the tension and release of tension into mechanical energy is very different from other patents that pull on the ocean floor or the land.

These are multiple benefits of this invention: (A). In the preferred embodiment, the apparatus is of sufficient length to put the float and rod components within several waves and wave troughs at the same time, which gives the suspended beam stability or inertia in an unstable environment. (B). The beam possesses sufficient mass and inertia which is resistive to motion of any individual float or group of floats. This resistive mass gives the machine components enormous power, as the weight of the beam is transferred back and forth from float to float.

In many patents, there is only one float being activated by one wave and there is a period between waves that a compressor or pump will stop working. (C). The compressor of the present invention (operated within a float) can be operated in very deep water and only needs the anchor to keep it from drifting off. (D) The floats will be designed so they can be run over with out damage to ships or the floats. The floats will extend deep in the water, so the attached cables or rods will not be caught in ships propellers. (E) This apparatus can be built in shorter sections and then rigidly bolted together during the installation. Section can be attached rigidly to make the beam longer or to make shapes like squares or grid shapes (hereinafter “grids”). This will make the beam heavier, more stable and cover more area with fewer anchors. That will makes it almost as stable as attaching the floats to the ocean floor.

It will be appreciated that the apparatus is not needed to be attached to the ocean floor but rather tethered to a ship. This tether arrangement permits mobility of the apparatus. For example the apparatus may be towed from a severe storm or hurricane. Further the ship may tend to the power converting apparatus of the invention. The vessel may serve as a mother ship.

The expense of installing devices like this will be great if we are to use them to power our coastal cities, so they must be very dependable and last a long time to recapture the investment. This apparatus is designed to be durable and powerful. The air compressors incorporated into the moveable floats can be used to compress air which can be collected and stored for reuse. Using the oceans energy instead of burning fossil fuels would greatly help our planet.

The machine components contained within each float can include a piston driven air compressor, a mechanical coupling connecting and moving the piston within the compressor cylinder, a component such as a drive pulley powering the mechanical coupling, a drive gear attached to the float, coupled to the drive pulley and engaged with the teeth of the drive rack. Wave action causes the float to move in relation to the drive rack. The drive rack may be attached to a retention spring located in the upper portion of the float. The retention spring serves to pull the float upward after having descended into a wave trough. The float may also include an air inlet or snorkel located at the upper portion of the float. Flexible, water tight baffles seal the bottom aperture of the float through which the drive rack extends. The baffles may be protected from abrasion by metal or similar shields. (It will be appreciated that other devices or machine mechanisms can be similarly adapted to the structure subject of pending application Ser. No. 11/473357, entitled Ocean Wave Energy Converter filed Jun. 22, 2006 and which is hereby incorporated herein by reference.)

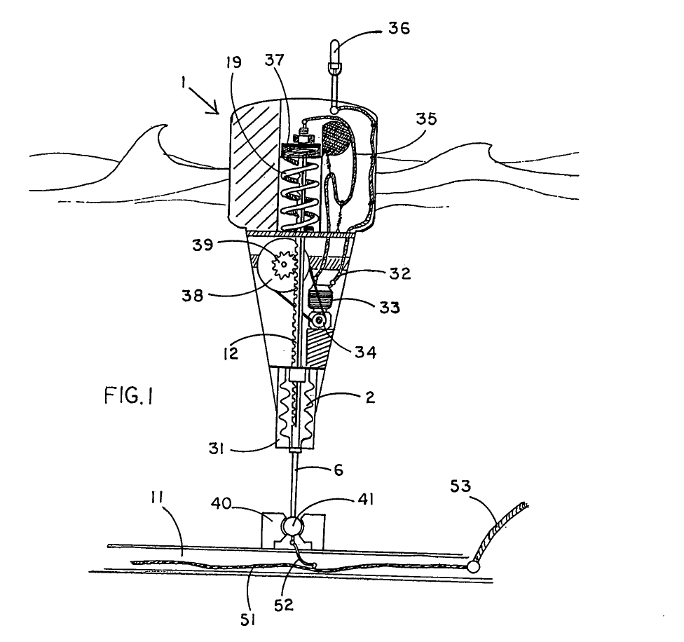

Referring to FIG. 1 (not drawn to scale), a buoyant float 1 comprising a housing is illustrated. Also illustrated are mechanisms including a retention spring 19 with the drive rack 12 attached to a cap plate 37 fixed at the top of the retention spring. The drive rack includes a portion that contains teeth that can engage the teeth of the drive gear 39. The drive rack extends the length of the float housing and extends or is attached to a rod 6 that is connected to the suspended beam 11. The drive rack extends through the flexible baffles 2 which may be shielded 31 from impact (e.g., passing vessels or fishermen). The connection of the rod to the beam is illustrated by example to comprise a knuckle 40 and pivoting component 41. Within the beam is a compressed air hose 51 and the air hose 52 from the instant float component which combine into a single larger hose 53. The air hose within the beam from the float is a continuation of the compressed air hose 35 extending from the air compressor. This hose arrangement facilitates collection of the compressed air and minimizes the unprotected exposure of the hoses.

It will be appreciated that the float housing moves up and down in response to the wave action. In contrast to the moving float, the drive rack (attached to the beam) remains relatively stationary. This causes the drive gear (attached to the housing) to rotate as it moves against the drive rack. The rotation of the drive gear turns a drive pulley 38 which in turn rotates a wheel 34 on the air compressor 33. This motion drives a piston within a cylinder of the air compressor. The resulting compressed air is conveyed through a tube 35 which may extend through the drive rack and into the beam.

An air supply is furnished from an aperture at the top of the float housing 36 and supplied through an air tube 32.

In one embodiment, the beam is suspended beneath the wave depth. Also because the multiple floats supporting the beam are simultaneously experiencing different wave actions (swells and troughs) the movement of the beam is limited. The beam is preferably of an elongated or other shape such that the attached floats are simultaneously experiencing multiple wave swells and troughs. Therefore there is constant “up and down” motion of the floats relative to the rods attached to the beam. This motion or movement powers the machine components, i.e., air compressors located in multiple floats.

The floats will move up and down at different times. The buoyant lifting force of a float rising in a swell may be cancelled by the action of a float descending into a trough. There may not be a net lifting of the beam of the apparatus but a transfer of its weight pulling on the floats.

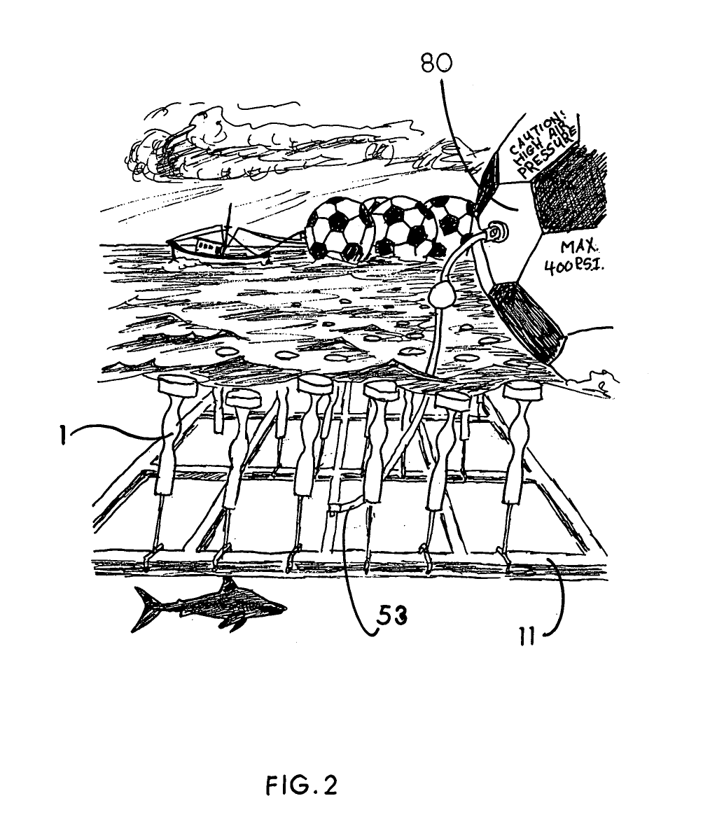

FIG. 2 illustrates the beams 11 forming a grid pattern. Multiple floats 1 are attached to the grid. Each float can move up and down in response to wave action. Also illustrated are the compressed air hose 53 exiting a beam and being in communication with an air intake value of a gas storage device 80.

In addition, this specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

I claim:

1. A buoyant float comprising a retention spring in communication with a drive rack fixed to a beam whereby vertical movement of the float causes the float to move in relation to the drive rack and causing a drive gear attached to the float and engaged with the drive rack to turn wherein the turning drive gear moves a drive pulley resulting in movement of a piston within an air pump.

2. The invention of claim 1 further comprising an air supply hose in communication with an air opening at a top of the float.

3. The invention of claim 1 further comprising a compressed air hose wherein the compressed air hose extends to the beam.

4. The invention of claim 1 wherein the rod extending from the float is pivotably attached to a knuckle component of the beam.

5. The invention of claim 1 wherein the float has a vertically elongated shape and one end is closed by flexible baffles.

6. An air compressor pump installed within a moveable float wherein the air compressor pump operates by movement of the float relative to the drive rack that turns a drive gear and results in movement of a piston of the air compressor pump.

7. The air compressor pump of claim 6 further comprising a hose containing compressed air from the air compressor pump and wherein the hose in conveyed through the drive rack to a beam.

8. An air compression system comprising an air compressor, a float moveable in relation to a drive rack, a drive gear engaged with the drive rack and turning with movement of the float and powering the air compressor.

9. The air compression system of claim 8 further comprising retention springs connected to the drive rack.

10. The air compression system of claim 8 further comprising a drive pulley connected to the drive gear

11. The air compression system of claim 8 wherein the float moves substantially up and down on the drive rack and the drive gear engaged with the drive rack rotates and powers a drive pulley that powers the air compressor.

12. A method of utilizing wave motion to compress air comprising the steps:
a) installing a float at the ocean surface wherein the float can move substantially up and down in response to wave motion;
b) installing a drive rack within the float wherein one end of the drive rack is fixed to a beam that is relatively stable;
c) placing a rotating drive gear that engages the drive rack and rotates as the float moves in relation to the drive rack;
d) placing the rotatable drive gear in communication with further moveable component; and
e) placing the moveable component in communication with a moveable piston of an air compressor.

13. The method of claim 12 further comprising using a plurality of floats positioned in order that one float will be in a wave trough concurrent with another float in a wave swell.
